(19) United States
(12) Patent Application Publication
(10) Pub. No.: US 2019/0120941 A1
(43) Pub. Date: Apr. 25, 2019

(54) ARRANGEMENT OF LIGHT SOURCES AND DETECTORS IN A LIDAR SYSTEM

(71) Applicant: Shenzhen Suteng JuChuang Technologies Ltd. Co., Shenzhen (CN)

(72) Inventors: Chunxin Qiu, Shenzhen (CN); Letian Liu, Shenzhen (CN)

(21) Appl. No.: 16/164,541

(22) Filed: Oct. 18, 2018

(30) Foreign Application Priority Data
Oct. 19, 2017 (CN) 201710978746.3
Dec. 1, 2017 (CN) 201711250321.7

(51) Int. Cl. G01S 7/481

(52) U.S. Cl. CPC G01S 7/4817; G01S 7/4816; G01S 7/4815

(57) ABSTRACT

The present application discloses an improvement arrangement of light sources and detectors in a LiDAR device. In one embodiment, the LiDAR device comprises an oscillating mirror that reflects the light beams from a plurality of light sources to enlarge the scanning region of the LiDAR device. In some embodiments, light sources and detectors are paired to produce accurate scanning results.

### RELATED APPLICATIONS

This US national application claims priority under the Paris Convention to Chinese Application No. 201710978746.3 titled LiDAR AND LiDAR CONTROL METHOD and filed on Oct. 19, 2017, and Chinese Application No. 201711250321.7 titled LIDAR AND LIDAR CONTROL METHOD and filed on Dec. 1, 2017, the entire content of both being incorporated herein in its entirety.

### FIELD OF INVENTION

The present disclosure relates generally to a Light Detection and Ranging (LiDAR) device, and more specifically to an improved arrangement of light sources and detectors in a LiDAR system.

### BACKGROUND

Autonomous driving vehicles use laser detecting and ranging devices to “see” and “sense” the environment for obstacle detection and avoidance. The basic principle of a LiDAR device is measuring time of flight (TOF) and converting time of flight into distance. These devices are generally used to map and measure the shape, location, and distance of objects in the vicinity. Light Detection and Ranging (LiDAR) devices are especially suited for such tasks.

Generally, a LiDAR device transmits a laser beam and receives a returned laser beam when it is reflected by a nearby object. By measuring the lapsed time between transmission and reception, the distance of a nearby object can be calculated. From the absence of returned laser beams, spaces that are free of obstacles can be mapped out. The shape of a nearby object, such as the contour and size of the object, can also be determined by comparing the transmitted laser beam with the returned laser beam, or by the absence thereof.

LiDAR devices used for autonomous driving vehicles are expected to monitor blind spot, recognize objects and pedestrians, map terrain, and avoid collision. LiDAR devices currently available on the market are rotating scanners. They are generally configured to rotate in order to achieve the 360° field of view of the surroundings. However, the vertical field of view that can be achieved by a LiDAR device is often small and limited. Further, rotating scanning LiDAR devices are bulky and expensive. The present application discloses an improved LiDAR device that can achieve a large field of view, high resolution in image mapping, accurate distance measurement, reliable obstacle detection, and affordable pricing.

### SUMMARY

Accordingly, it is an objective of the present disclosure to teach an advanced LiDAR system in which the light sources and detectors are configured to broaden the scanning region and to achieve accurate obstacle detection.

In some embodiments, a Light Detection and Ranging (LiDAR) system comprises a light source, a light detector, a mirror system and a control system. The light source comprises a plurality of laser emitters. Each laser emitter is configured to generate a laser beam. The light detector comprises a plurality of photon detectors. The mirror system is configured to change the direction of outgoing laser beams to scan a target region. In some embodiments, the mirror system comprises an oscillating Micro Electro-Mechanical System (MEMS) mirror to produce. The control system is configured to control the position of the MEMS mirror to steer an outgoing laser beam to the target region.

In one embodiment, the light source comprises 2N+1 laser emitters. The angle between the laser beams of any two adjacent laser emitters is the same. In one embodiment, the angle between the laser beams of any two adjacent laser emitters is not zero. In one embodiment, the plurality of laser emitters is in a same plane.

In some embodiments of the LiDAR system, the light detector comprises an array of photon detectors. The array of photon detectors is arranged to receive incoming laser beams, which are the outgoing laser beams reflected by objects in the target region. In one embodiment, the photon detectors are avalanche photon detectors.

In some embodiments, the LiDAR system further comprises a first lens system and a second lens system. The first lens system is placed in between the light source and the mirror system. The second lens system is placed in front of the light detector. In one embodiment, the first lens system comprises one or more collimators, each configured to collimate a laser beam generated by a laser emitter of the light source. In one embodiment, the second lens system comprises one or more focusing devices, each configured to focusing an incoming laser beam onto a photon detector.

In some embodiments, the light detector comprises 2N+1 photon detectors. The angle between the central axis of any two adjacent photon detectors is the same. In one embodiment, the angle between the central axis of any two adjacent photon detectors is zero. In one embodiment, the plurality of photon detectors is in a same plane.

In some embodiments, the plurality of photon detectors is divided into different groups, with each group of photon detectors comprising at least two photon detectors. Each group of photon detectors is in the same plane and different groups of photon detectors are in different planes. In one embodiment, the central axis of any photon detector in one group and that of its adjacent photon detector in the same group form an angle that is not zero.

In some embodiments, each laser emitter is paired with a photon detector. The number of laser emitters and the number of photon detectors are the same. In some embodiments, the laser emitters and the photon detectors are not paired. The number of laser emitters and the number of photon detectors are not the same.

### BRIEF DESCRIPTION OF THE DRAWINGS

These and other features of the present disclosure will become readily apparent upon further review of the following specification and drawings. In the drawings, like reference numerals designate corresponding parts throughout the views. Moreover, components in the drawings are not necessarily drawn to scale, the emphasis instead being placed upon clearly illustrating the principles of the present disclosure.

FIGS. 1a-1b are illustrations of two exemplary LiDAR systems in accordance to embodiments disclosed herein.

FIG. 2 is a block diagram illustrating an exemplary LiDAR system in accordance to an embodiment disclosed herein.

FIG. 3a-3d illustrates exemplary arrangements of laser emitters in the light source in accordance to embodiments disclosed herein.

FIG. 4 is a flowchart illustrating an exemplary control process implemented in a LiDAR control system.

FIG. 5 is a block diagram of an exemplary lens system for a LiDAR system in accordance to an embodiment disclosed herein.

FIG. 6 illustrates an exemplary setup in a LiDAR system for receiving incoming laser beams.

FIGS. 7a-7c illustrate exemplary arrangements of photon detectors in the light detector in accordance to embodiments disclosed herein.

### DETAILED DESCRIPTION

Embodiments of the disclosure are described more fully hereinafter with reference to the accompanying drawings, in which preferred embodiments of the disclosure are shown. The various embodiments of the disclosure may, however, be embodied in many different forms and should not be construed as limited to the embodiments set forth herein. Rather, these embodiments are provided so that this disclosure will be thorough and complete, and will fully convey the scope of the disclosure to those skilled in the art.

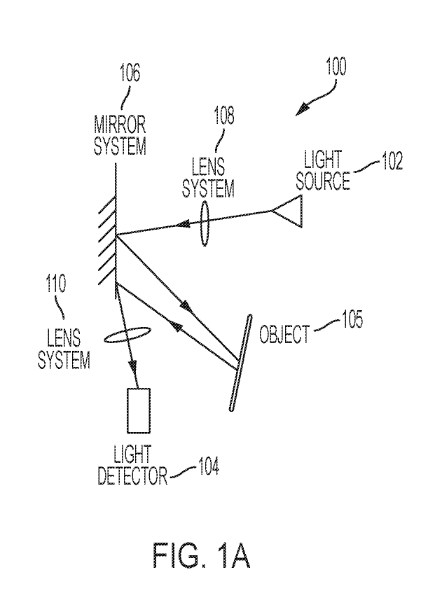

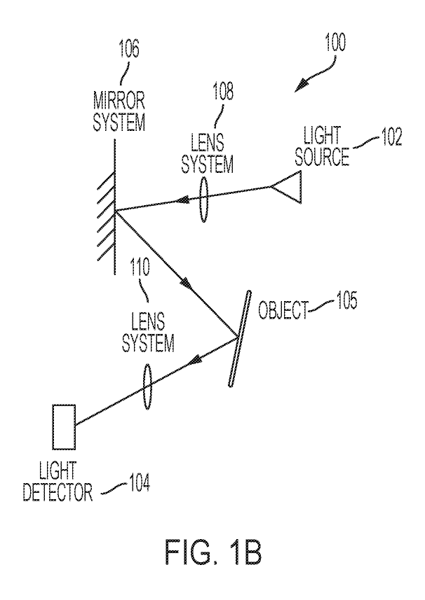

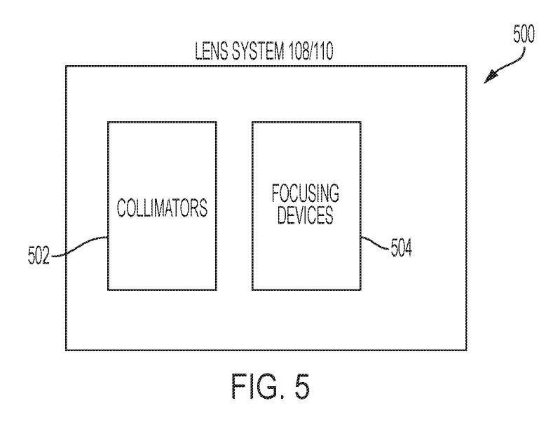

In referring to FIG. 1a, an exemplary LiDAR system 100 is shown to comprise a light source 102, a light detector system 104, a mirror system 106, lens systems 108 and 110, and a control system 112. The light source 102 comprises a plurality of laser emitters, each emitting a laser beam directed at the mirror system 106. In some embodiments, a lens system 108 may be placed in the path of the laser beams before the mirror system 106. In some embodiments, the lens system 108 may comprise collimators that are used to collimate the laser beams from the laser emitters to ensure that the laser beams are focused and aligned before the laser beams reach the mirror system 106. In later sections of this disclosure and in FIG. 5, the lens systems 108 and 110 are discussed in more detail.

The mirror system 106 is configured to direct the laser beams coming from the light source 102 towards a desired target region. For example, a desired target region may be a region that needs to be scanned for objects or obstacles. The laser beams, after being reflected by the mirror system 106, form outgoing laser beams directed towards the target region for image recognition and obstacle detection, for instance, to detect objects, pedestrians, or obstacles.

In some embodiments, the mirror system 106 comprises a MEMS system configured to oscillate to change the direction of the outgoing laser beams. In one embodiment, the mirror system 106 may comprise a Micro-Electro-Mechanical System (MEMS) mirror. The MEMS mirror is configured to change its orientation to reflect a laser beam towards a desired direction to form an outgoing laser beam. In some embodiments, the MEMS mirror may be controlled to continuously change its orientation. The oscillating movement of the MEMS mirror may be described as a combination of rotation around an axis in the zenith direction and vibration around an axis perpendicular to the zenith axis. The continuous oscillation of the MEMS mirror permits the outgoing laser beam to continuously scan a target region, for example, an area in the shape of square.

In the process of scanning a target region, an outgoing laser beam may hit an object 105 located in the target region that reflects the outgoing laser beam back towards the mirror system 106. A reflected outgoing laser beam becomes an incoming laser beam. As shown in FIG. 1a, the incoming laser beam does not diverge from the outgoing laser beam by much and travels towards the mirror system 106 before being reflected and received by the light detector 104. In some embodiments, a lens system 110 is placed in between the mirror system 106 and the light detector 104. The lens system 110 may comprise focusing devices that are configured to focus incoming laser beams onto respective light detectors.

In some embodiments, the incoming laser beams are not re-directed by the mirror system 106 before being received by the light detector 104. As shown in FIG. 1b, the incoming laser beams coming from the target region go through a lens system 110 before reaching the light detector 104. The lens system 110 may include focusing devices that are configured to focus the incoming laser beams onto the light detector 104.

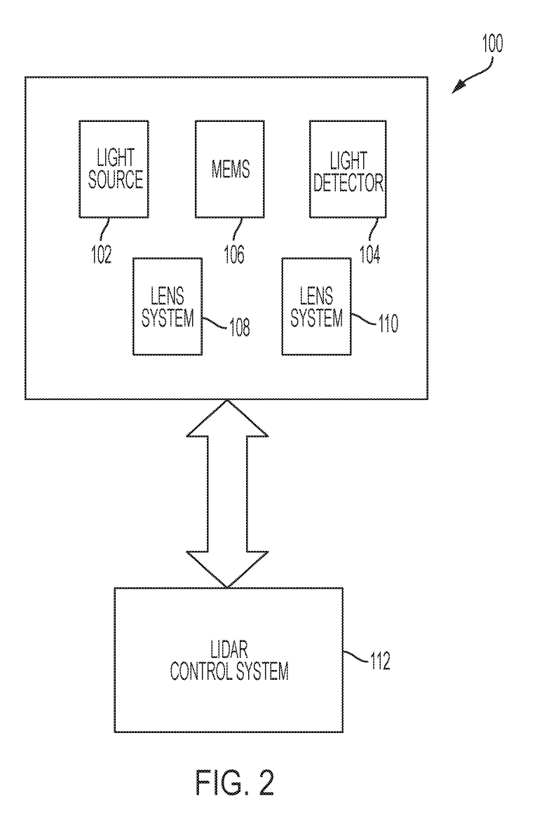

In the LiDAR system 100, the mirror system may comprise one or more MEMS mirror that is configured to steer outgoing laser beams onto a target region. In some embodiments, multiple laser emitters share one MEMS mirror. The MEMS mirror may be shared among the multiple laser emitters. The movement of the MEMS mirror is controlled by the LiDAR control system 112. FIG. 2 illustrates a block diagram of an exemplary LiDAR system 100. The LiDAR control system 112 is configured to control the movement of the MEMS mirror, the emissions of the laser beams by the light source 102, and the reception of incoming laser beams by the light detector 104. In some embodiments, the lens system 108 and/or 110 are controlled by the LiDAR control system 112 for runtime adjustment.

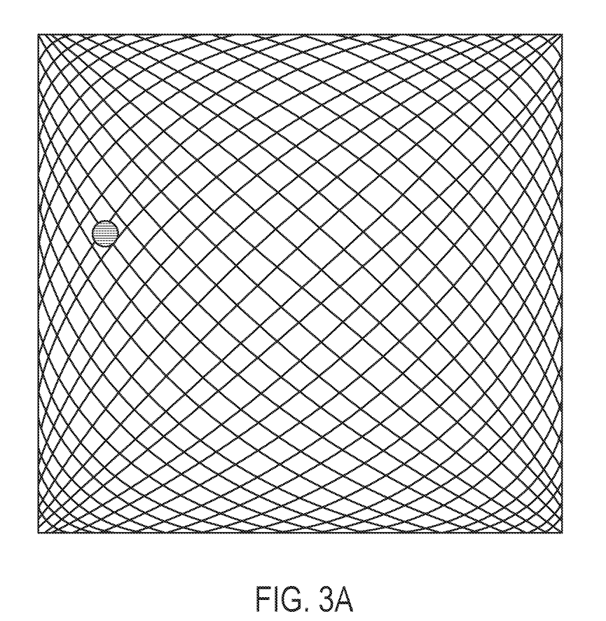

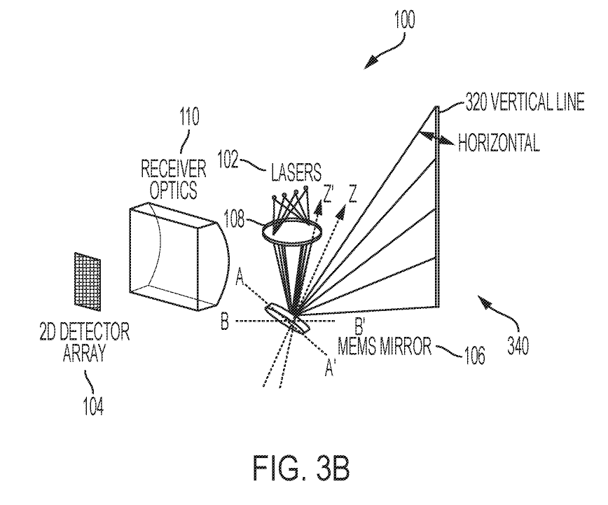

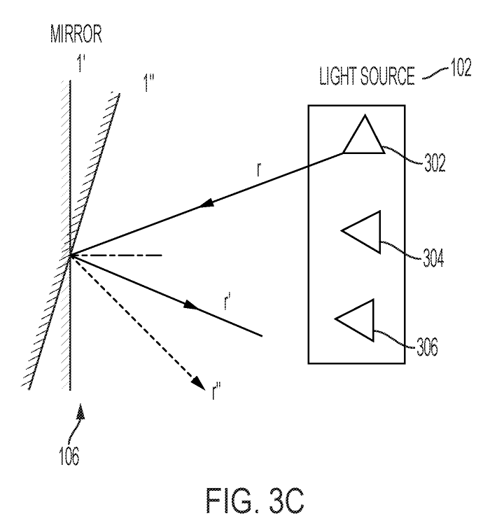

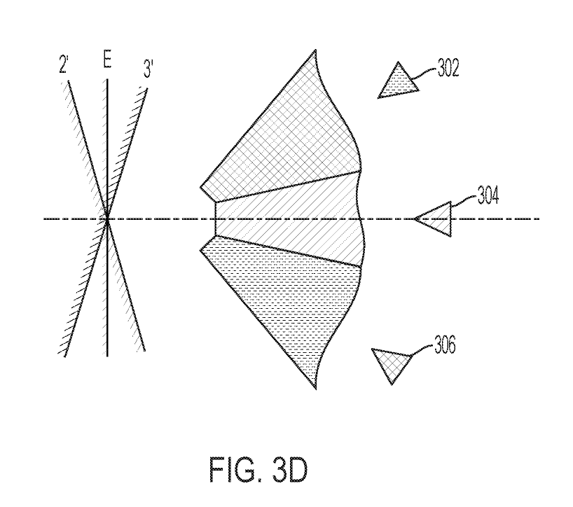

During runtime, the LiDAR control system 100 first determines a target area and then controls the multiple laser emitters to ensure the entire target area is scanned by the multiple laser beams. The division scheme can vary from embodiment to embodiment. In some embodiments, a single laser emitter can cover a small area. For example, FIG. 3a illustrates a square area covered by a single laser emitter. The lines in the square show the track of the laser beam as it is being continuously directed by the mirror system 106. In some embodiments, multiple laser emitters are arranged so each laser emitter scans a square area shown in FIG. 3a and the total area covered by the LiDAR system is a sum of the small square areas scanned by single laser emitters. To avoid “blind spots,” some overlapping of the scanned areas of two adjacent laser emitters may be necessary.

FIG. 3b shows how an array of laser emitters can cover a larger rectangular area. In FIG. 3b, multiple laser emitters are arranged in a straight line and the laser beams from the multiple laser emitters go through the lens system 108 and become collimated before reaching the MEMS mirror 106. After being reflected by the MEMS mirror 106, the multiple laser beams are steered towards the target region. The outgoing laser beams also form a straight line 320 if the MEMS mirror 106 is a 1-dimensional MEMS mirror, as shown in FIG. 3b. The outgoing laser beams may form a square if the mirror on a projection plane 340 in the target area. Under the control system 112, the MEMS mirror 106 is a 2-dimensional MEMS mirror (not shown). changes its orientation to change the directions of the outgoing laser beams. For instance, as the MEMS mirror 106 moves from AA′ to BB′, the laser beams will be directed towards the left side of the target region, scanning the region to the left side of the vertical line 320. As the MEMS mirror 106 tilts from axis z to axis z′, the laser beams will be directed to a region above the projection plane 340. Because of the use of multiple laser emitters, the area monitored by the LiDAR system is enlarged. The total monitored area is the sum of the area scanned by individual laser beams.

FIG. 3c further illustrates how an oscillating mirror system 106 produces an enlarged sweeping region. As shown in FIG. 3c, the mirror system 106 is in position 1′ at time t₀. The laser beam r from the laser emitter 202 is reflected by the mirror system 106 and becomes the outgoing laser beam r′. At time t₁, the mirror system 106 has changed its orientation to position 1″. Because the light source 102 remains stationary, the laser beam r coming from the laser emitter 202 does not change direction. After being reflected by the mirror system 106 now at position 1″, the laser beam r becomes the outgoing laser beam r″. Therefore, from time t₀ to time t₁, the laser beam from the laser emitter 202 sweeps the region between beam r′ and beam r″ and can detect obstacles inside the region.

FIG. 3d further illustrates how the oscillating mirror system 106 increases the vertical FOV of the LiDAR system 100. For illustration purpose, the light source 102 of the LiDAR system 100 is shown to comprise an array of three laser emitters 302, 304, and 306. The mirror system 106 oscillates from position 2′ to position 3′. As the mirror system 106 moves from position 2′ to 3′, the light beam from the emitter 202 (shaded with dots) sweeps the dotted cone region. The light beam from the emitter 204 (shaded with lines) sweeps the lined cone region. The light beam from the light source 206 (shaded with grids) sweeps the gridded cone region. As a result, the total region swept by the laser beams of the light source 102, i.e., the combined area of the three cone regions, has been substantially increased.

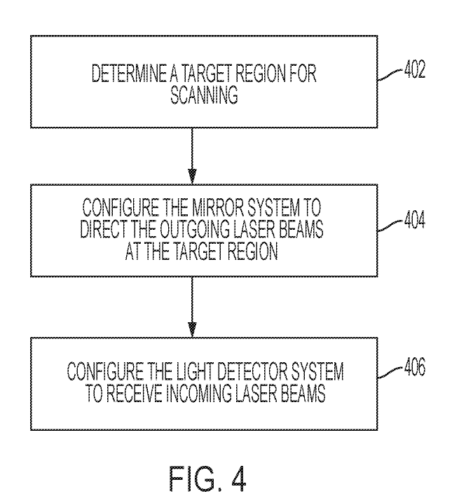

The movements of the oscillating mirror system 106 are controlled by the LiDAR control system 112. The control system 112 first selects a target region to be scanned. By controlling the orientation of the mirror system, the outgoing laser beams can be focused on a target region selected by the LiDAR control system 112. In one embodiment, the region may be selected based on some preliminary scanning results. In another embodiment, the target region may be selected based on a pre-determined algorithm. After a target region has been selected, the control system 112 adjusts the mirror system 106 so that the outgoing laser beams are aimed at the target region. Accordingly, the light detector system 104 needs adjustment as well in order to receive incoming laser beams, which have changed direction due to the change of orientation of the mirror system 106. FIG. 4 is a flow chart illustrating an exemplary process of the LiDAR control system 112. In the first step, the control system 112 determines a target region for scanning (step 402). After the target region has been determined, the control system 112 configures the mirror system to direct the outgoing laser beams at the target region (step 404). The control system 112 then configures the light detector system 104 accordingly to properly receive incoming laser beams (step 406).

As shown in FIG. 1, the incoming laser beams are the reflected beams after the outgoing laser beams hit a surface of an object in the target region. The light detector 104 is configured to receive the incoming laser beams. Before the light detector system 104, a lens system 110 may be placed in the path of the incoming laser beams. FIG. 5. illustrates an exemplary lens system 500 that comprises collimators 502 and/or focusing devices 504. In some embodiments, the lens system may comprise only collimators 502, such as the lens system 108. In one embodiment, the lens system 108 may comprise multiple collimators, one for each outgoing laser beam. In some embodiments, the lens system 500 may comprise only focusing devices 504, such as the lens system 110. In one embodiment, the lens system 110 may comprise multiple focusing devices, one for each incoming laser beam. In some embodiments, the focusing device 504 may be used in conjunction with the collimator 502, or in lieu of the collimator 502. In some embodiments, the collimator 502 and the focusing device 504 can be used selectively. The LiDAR control system 112 can be configured to selectively use one or more devices of the lens system 108/110.

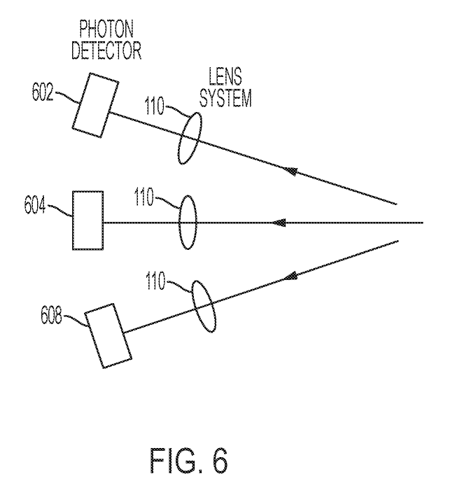

After going through the lens system 110, the laser beams reach the detector system 104. See FIG. 6. The detector system 104 may comprise a plurality of light detectors, e.g., avalanche photo detectors. In some embodiments, each photon detector, 602, 604, 608, is paired with a laser emitter. The number of photon detectors in the detector system 104 is the same as the number of light emitters in the light source 102. Each photon detector is configured to receive the light beam from the corresponding light emitter. To accomplish such configuration, the position and orientation of each photon detector are adjustable and can be adjusted according to the position and orientation of its corresponding light emitter. In other embodiments, the photon detectors are not paired with the emitters. The number of photon detectors does not necessarily match that of laser emitters.

In some embodiments, the photon detectors in the light detector system 104 are arranged in a one-dimensional or two-dimensional array. In some embodiments, the laser emitters in the light source 102 are also arranged in a one-dimensional or two-dimensional array, similar to the photon detectors in the light detector system 104.

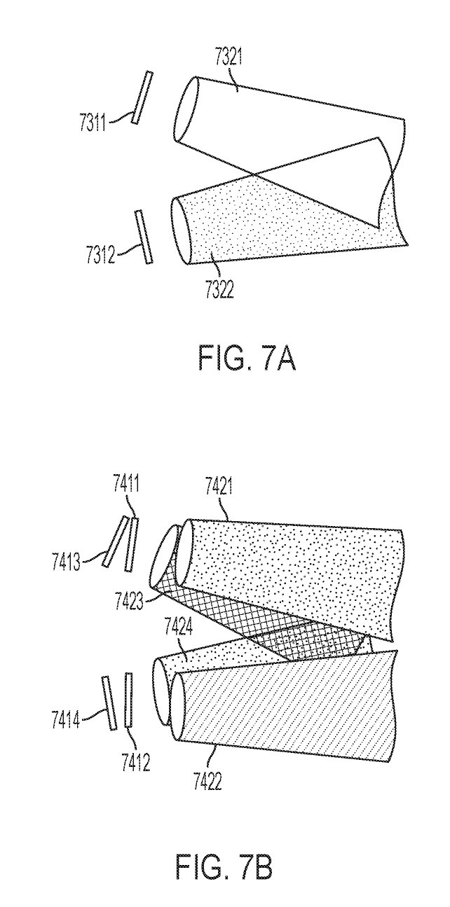

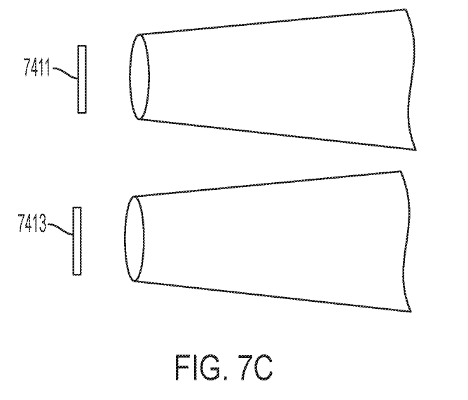

FIGS. 7a-7c show different arrangements of light detectors. The differently-shaded cone regions in front of the detectors (shown as narrow rectangles) represent the scanning region covered by each detector. For example, in FIG. 7a, the detector 7311 and the detector 7312 each cover the region 7321 and 7322 respectively. In FIG. 7a, the two regions 7321 and 7322 overlap to ensure there is no “blind spot.”

In FIG. 7b, four photon detectors, 7411, 7412, 7413, and 7414, are divided into two groups. The detectors 7411 and 7412 are in one group. The central axis of these two detectors are in one plane. The detectors 7413 and 7414 are in another group. The central axis of these two detectors are in another plane. In this embodiment, the photon detectors are divided into different groups. Photon detectors in the same group are positioned in the same plane. Photon detectors in different groups are in different planes. In some embodiments, for photon detectors that are in the same group, two adjacent photon detectors form an angle that is zero, as shown in FIG. 7b. In other embodiments, the angle may be non-zero.

In FIG. 7c, the four photon detectors, 7411, 7412, 7413, and 7414, are in a different arrangement. Viewed from the side of the LiDAR system 100, the two detectors 7412 and 7414 are hidden behind the detectors 7411 and 7413.

In some embodiments, the photon detectors are positioned symmetrically. For example, in one embodiment, the central axis of any two adjacent photon detectors form an angle that is not zero. The angle is the same between any two adjacent photon detectors. In one embodiment, the central axis of a photon detector forms an angle with a horizontal plane and the angle is the same for all photon detectors. The angle can be zero in one embodiment or non-zero in another embodiment.

Although the disclosure is illustrated and described herein with reference to specific embodiments, the disclosure is not intended to be limited to the details shown. Rather, various modifications may be made in the details within the scope and range of equivalents of the claims and without departing from the disclosure.

1. A Light Detection and Ranging (LiDAR) system, comprising:
a light source, said light source comprising a plurality of laser emitters, each laser emitter configured to generate an outgoing laser beam;
a light detector comprising a plurality of photon detectors;
a mirror system for changing the direction of outgoing laser beams to scan a target region;
a control system for controlling the LiDAR system.

2. The LiDAR system of claim 1, wherein the mirror system comprises a Micro-Electro-Mechanical Systems (MEMS) mirror.

3. The LiDAR system of claim 2, wherein the control system is configured to control the position of the MEMS mirror to steer an outgoing laser beam to the target region.

4. The LiDAR system of claim 3, wherein the light source comprises 2N+1 laser emitters and wherein the angle between the laser beams of any two adjacent laser emitters is the same.

5. The LiDAR system of claim 4, wherein the angle between the laser beams of any two adjacent laser emitters is not zero.

6. The LiDAR system of claim 5, wherein the plurality of laser emitters is in a same plane.

7. The LiDAR system of claim 3, wherein the plurality of laser emitters is divided into two groups, with each group of laser emitters comprising at least two laser emitters, and wherein each group of laser emitters is in a same plane and different groups of laser emitters are in different planes.

8. The LiDAR system of claim 7, wherein the laser beam from any laser emitter in a group forms an angle with the laser beam of an adjacent laser emitter in the same group, and wherein said angle is not zero.

9. The LiDAR system of claim 1, further comprising a first lens system, wherein the first lens system is placed in between the mirror system and the light source and wherein the first lens system comprises a collimator for collimating each of the laser beams from the light source.

10. The LiDAR system of claim 1, wherein the light detector comprises an array of photon detectors, and wherein the array of photon detectors is arranged to receive incoming laser beams that are the outgoing laser beams reflected by objects in the target region.

11. The LiDAR system of claim 10, wherein the photon detectors are avalanche photon detectors.

12. The LiDAR system of claim 1, further comprising a second lens system placed in front of the light detector, wherein the second lens system comprises a focusing device to focus each of the incoming laser beams onto the light detector.

13. The LiDAR system of claim 10, wherein each photon detector is paired with each laser emitter and wherein the number of photon detectors and the number of laser emitters are the same.

14. The LiDAR system of claim 10, wherein the photon detectors and the laser emitters are not paired and wherein the number of photon detectors and the number of laser emitters are not the same.

15. The LiDAR system of claim 10, wherein the angle between the central axis of any two adjacent photon detectors is the same.

16. The LiDAR system of claim 15, wherein the angle between the central axis of any two adjacent photon detectors is not zero.

17. The LiDAR system of claim 14, wherein the plurality of photon detectors is in a same plane.

18. The LiDAR system of claim 10, wherein the plurality of photon detectors is divided into different groups, with each group of photon detectors comprising at least two photon detectors, and wherein each group of photon detectors is in a in the same plane and different groups are in different planes.

19. The LiDAR system of claim 18, wherein the central axis of an photon detector in one group and that of its adjacent photon detector in the same group form an angle that is not zero.
